(19) United States
(12) Patent Application Publication
(10) Pub. No.: US 2010/0058481 A1
(43) Pub. Date: Mar. 4, 2010

(54) NON-DISPLAYING METHOD OF SECRET INFORMATION AND INFORMATION PROCESSING DEVICE

(75) Inventor: Katsumi YAGITA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/500,590

(22) Filed: Jul. 9, 2009

(30) Foreign Application Priority Data
Aug. 26, 2008 (JP) 2008-216370

(51) Int. Cl. G06F 21/00; G06F 15/16

(52) U.S. Cl. 726/26; 709/204

(57) ABSTRACT

A screen based on display information is displayed on a display device, secret information in the display information is discriminated based on a predetermined condition, the secret information is non-displayed by replacing the secret information with specified characters or images, and the display information other than the secret information and the post-converting secret information are transmitted to another device.

### CROSS-REFERENCE OF RELATED APPLICATION

This application is based upon and claims the benefit of priority of the prior Japanese Patent Application No. 2008-216370, filed on Aug. 26, 2008, the entire contents of which are incorporated herein by reference.

### FIELD

Disclosed is a technology of non-displaying (making unrecognizable) secret information when sharing a display screen of an information processing device.

### BACKGROUND

A conventionally known technology is that a computer on a monitored-side extracts a window and input data displayed corresponding to a user's operation as a screen log, transmits the screen log to another computer, and another computer reproduces the display screen based on the screen log and monitors the display screen. The display screen is thereby shared between the computers, which enables a support such as operating the monitored computer from the computer in a remote place.

Moreover, such a device is known that the screen data and the input data given by the user's operation are recorded, the recorded input data is processed softwarewise, the screen data of the processed result is compared with the screen data based on the user's operation, thereby automating a test for the software.

Furthermore, in existing computer, when a user inputs secret information such as a password for authentication, inputted characters are not echo-backed, i.e., are non-displayed (made unrecognizable) in consideration in terms of security. Alternatively, a contrivance is that the inputted secret information is converted into unrecognizable symbols (e.g unprintable characters) such as “#” and “•” and is thus made unrecognizable on the screen.

Further, such a technology is disclosed that a data collecting unit collects the data of the monitored-side computer, the secret information in the collected pieces of data is stored in a specified address, then mosaic-processed and thus distributed when the secret information is requested from another computer.

Moreover, the following Patent documents disclose the technologies as the prior arts related to the invention of the present application.
[Patent document 1]
Japanese Patent Laid-Open Publication No. H10-269117
[Patent document 2]
Japanese Patent Laid-Open Publication No. H11-065975
[Patent document 3]
Japanese Patent Laid-Open Publication No. H11-196090
[Patent document 4]
Japanese Patent Laid-Open Publication No. H5-274186
[Patent document 5]
Japanese Patent Laid-Open Publication No. 2003-199179

### SUMMARY

As described above, when the monitored-side computer reproduces the display screen on the monitoring-side with fidelity on the basis of the screen data and the input data, a problem is that the password for the authentication, etc is to be displayed on the reproduced display screen.

Further, the device, which distributes the mosaic-processed secret information, requires a dedicated data collecting unit that collects the secret information and stores the secret information as data for distribution in a specified address, resulting in a problem that a device configuration becomes complicated.

For solving the problems given above, the information processing device of the present application generates display information by an arithmetic process, gets a display device to display a screen based on the display information, discriminates the secret information in the display information based on a predetermined condition, non-displays the secret information by converting the secret information, and transmits the display information other than the secret information and the post-converting secret information to another device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a schematic diagram of a screen shared system.

FIG. 2 is a block diagram of a server-side information processing device.

FIG. 3 is a block diagram of a client-side information processing device.

FIG. 4 is an explanatory diagram of a screen display process.

FIG. 5 is an explanatory diagram of a screen sharing process.

FIG. 6 is a diagram illustrating an example of implementing a dynamic library.

FIG. 7 is an explanatory diagram of a non-displaying condition setting method.

FIG. 8 is an explanatory diagram of a condition table. FIG. 9 is a diagram illustrating an example of a condition setting screen.

FIG. 10 is an explanatory diagram of a non-displaying method.

FIG. 11 is an explanatory diagram of an operation of a linkup server unit.

FIG. 12 is an explanatory diagram of an operation of a linkup client unit.

### DESCRIPTION OF EMBODIMENTS

Embodiments of the present invention will hereinafter be described with reference to the drawings. A configuration in the following embodiment is an exemplification, and the present invention is not limited to the embodiment discussed herein.

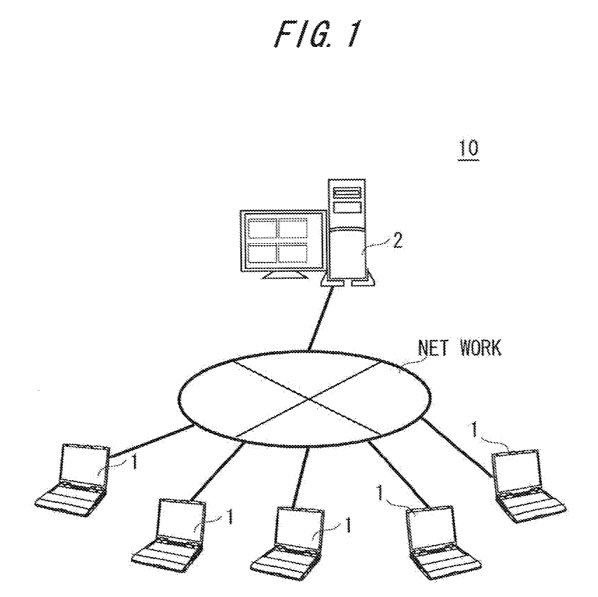

FIG. 1 is a schematic diagram of a screen display shared system according to one embodiment of the present invention.

A screen display shared system 10 includes an information processing device 1 defined as a monitored side, i.e., a server side which outputs display information, and another information processing device 2 defined as a monitoring side, i.e., a client side which receives the display information.

The information processing device 1 on the server side will hereinafter be also referred to as the server-side device 1. The server-side device 1 extracts the display information about windows, input data, etc that are displayed on own display device in response to a user's operation, and transmits the extracted display information to the information processing device 2 on the client side. The information processing device 2 reproduces a display screen based on the display information received from the information processing device 1 via a network, and monitors the display screen.

The information processing devices 1 and 2 share the display screen with each other, thereby enabling, for example, an operator of the information processing device 2 in a remote place to support the information processing device 1.

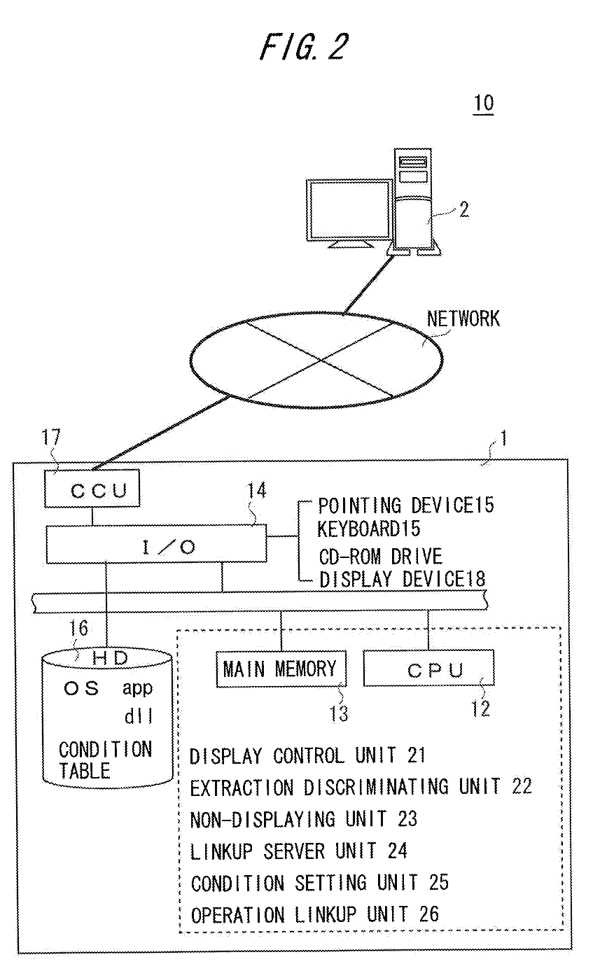

FIG. 2 is a schematic diagram of the information processing device 1. As depicted in FIG. 2, the information processing device 1 is a computer including a CPU (Central Processing Unit) 12, a main memory 13, an input/output (I/O) port 14, etc.

Connected to the I/O port 14 are an input unit 15 such as a keyboard or a pointing device for inputting an instruction of a user, a storage unit 16 such as a hard disc drive that stores data and software for an arithmetic process, a communication control unit (CCU) 17 which controls communications with other computers, a display device 18 and so on.

The storage unit 16 contains programs such as Operating System (OS), a driver, a dynamic link library (dll) and application software. Further, the storage unit 16 also stores a condition table in which conditions for non-displaying the display information are set, GUI screen data and user data.

The CPU 12 properly reads the programs such as the OS and the dll from the storage unit 16 via the main memory 13 and executes the programs, thereby executing the arithmetic process about the information read from the CCU 17 and the storage unit 16. Then, the CPU 12 generates the display information as a processed result of the arithmetic process. Note that the generation of the display information in the embodiment is not limited to generating new items of data for the display in the arithmetic process, but may include reading the existing data and a display object from the storage unit and setting the data and the display object as the display information. Furthermore, the generation of the display information may also include setting, as the display information, the data inputted from the input unit 15, the CCU 17 and so on.

Moreover, the CPU 12 functions, through the arithmetic process, as a display control unit 21, an extraction discriminating unit 22, a non-displaying unit 23, a linkup server unit 24, a condition setting unit 25 and an operation linkup unit 26.

The display control unit 21 displays a screen based on the generated display information on the display device 18. Note that the display control unit 21 may also be a different circuit from the CPU 12, e.g., a graphics processing unit (GPU).

The extraction discriminating unit 22 acquires the display information from the storage unit 16, the input unit 15, etc, when displaying the display information on the display device 18 by executing the application software. Further, the extraction discriminating unit 22 discriminates secret information contained in the display information on the basis of the non-displaying condition set in the condition table in the storage unit 16.

The non-displaying unit 23 non-displays (or makes unrecognizable) the secret information discriminated by the extraction discriminating unit 22 by converting the secret information into predetermined codes such as •, *, or into blanks such as a space, etc.

The linkup server unit 24 establishes a Peer-to-Peer connection with the client-side device 2. The linkup server unit 24 transmits the display information other than the secret information transferred from the extraction discriminating unit 22 and the converted secret information transferred from the non-displaying unit 23 to the client-side device 2. Note that the linkup server unit 24 may also be referred to as a transmitting unit.

A method of transferring and receiving the display information between the extraction discriminating unit 22 and the linkup server unit 24 is not particularly specified. For example, in a system adopting Windows (registered trademark) as the OS, the linkup server unit 24 acquires the display information outputted from the extraction discriminating unit 22 in such a way that. On the other hand, in a system adopting UNIX (registered trademark) as the OS, the display information extracted by the extraction discriminating unit 22 is transferred to the linkup server unit 24 via process-to-process communications or a driver.

Note that if the server-side device 1 is not connected to the client-side device 2, the extraction discriminating unit 22 does not transfer the display information to the linkup server unit 24, or alternatively the linkup server unit 24 discards the display information transferred from the extraction discriminating unit 22.

The condition setting unit 25 sets the non-displaying condition for the display information in the condition table of the storage unit 16 in response to a user's input. Incidentally, a method of setting the non-displaying condition is not limited to a specific method. The non-displaying condition may be inputted through a setting screen that is displayed on the display device 18, or may be described in an operating environment file.

The screen display shared system 10 in the embodiment displays the GUI (Graphical User Interface) such as a window, a dialog box, an icon, a mouse cursor among the display information. The screen display shared system 10 also non-displays pieces of data such as characters and images in the window and the dialog box. Therefore, a type of Application Program Interface (API) such as “WRITE” in which to write the data is specified as the non-displaying condition. Note that the non-displaying condition may be, without being limited to the above, sufficient if capable of distinguishing the data that is set in a non-displaying mode. For instance, names of items of a spreadsheet program, names of tags of an HTML (HyperText Markup Language) document, an attribute value in a display field in an input form, etc may also be available as the non-displaying condition.

In the case of converting the inputted characters into unrecognizable symbols and displaying these unrecognizable symbols as in the input form of a password, a non-displaying attribute is set in the display field of the password. Therefore, the value in this display field is determined to be the secret information under the condition that a non-displaying attribute is set in the attribute of the display field.

Further, the server-side device 1 can set a range for applying the non-displaying condition. The setting of the non-displaying condition range can involve using, e.g., a user's log-in name, a program name and a program number defined as a unique number allocated to an already-started program. In the case of specifying none of the non-displaying condition range, i.e., in the case of setting none of application range of the non-displaying condition, the discriminating unit 22 determines that all the display data is not the secret information. Accordingly, the non-displaying unit 23 does not execute the non-displaying process of the display information. While on the other hand, in the case of setting all the display information as the non-displaying condition range, the discriminating unit 22 determines whether the information is the secret information with respect to all the display information.

The operation linkup unit 26 converts the information on the operation in the client-side device 2, which is received from the client-side device 2 via the CCU 17, as in the case of the information inputted from the input unit such as the keyboard and the pointing device of the server-side device 1. With this conversion, the user of the client-side device 2 can remote-control the server-side device 1.

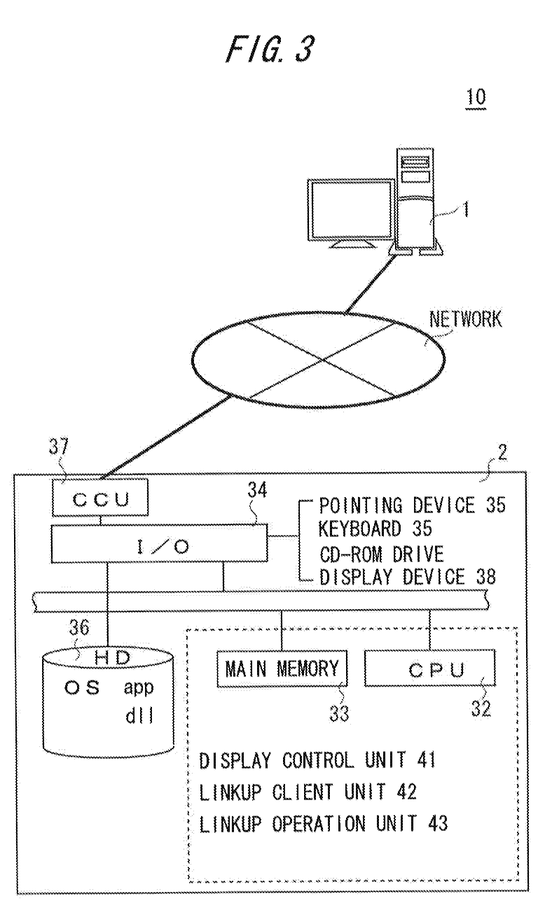

FIG. 3 is a schematic diagram of the client-side information processing device 2. As depicted in FIG. 3, the information processing device 2 is a computer including a CPU 32, a main memory 33, an input/output (I/O) port 34, etc.

Connected to the I/O port 34 are an input unit 35 such as the keyboard or the pointing device for inputting the instruction of the user, a storage unit 36 such as the hard disc drive that stores the data and the software for the arithmetic process, a communication control unit (CCU) 37 which controls the communications with other computers, a display device 38 and so on.

The storage unit 36 stores programs such as Operating System (OS), the driver, the dynamic link library (dll) and the application software.

The CPU 32 properly reads the programs such as the OS and the software from the storage unit 36 via the main memory 33 and executes the programs, thereby executing the arithmetic process about the information read from the CCU 37 and the storage unit 36. Through this arithmetic process, the CPU 32 functions as a display control unit 41, a linkup client unit 42 and a linkup operation unit 43.

The display control unit 41 controls the display device 38 to display a screen based on the display information the linkup client unit 42 receives from the server-side device 1 other than the secret information and the converted secret information.

The linkup client unit 42 establishes the Peer-to-Peer connection with the server-side device 1. The linkup client unit 42 receives the display information transmitted from the linkup server unit 24 other than the secret information and the converted secret information. Note that the linkup client unit 42 is also referred to as a receiving unit.

A display mode of the screen based on the display information received by the linkup client unit 42 is not particularly limited. For example, a desktop of the server-side device 1 may be displayed in the window or on the entire screen of the display device 38, to reproduced the screen displayed on the display device 18 of the server-side device 1 in the window or on the display device 38 of the client-side device 2. Another available scheme is that one single client-side device 2 that is connected with the server-side devices 1 operates a plurality of linkup client units 42, to monitor the screens of each of the plurality of server-side devices 1 while displaying the display screens of the respective server-side devices 1 in the windows.

An operation of sharing the screen between the server-side device 1 and the client-side device 2 will next be discussed.

The user can use the general type of application software such as a word processor and the spreadsheet software by arbitrarily installing the application software into the server-side device 1. Hence, the extraction discriminating unit 22 in the embodiment is capable of determining whether the display information corresponding to any unspecified application software contains the secret information or not.

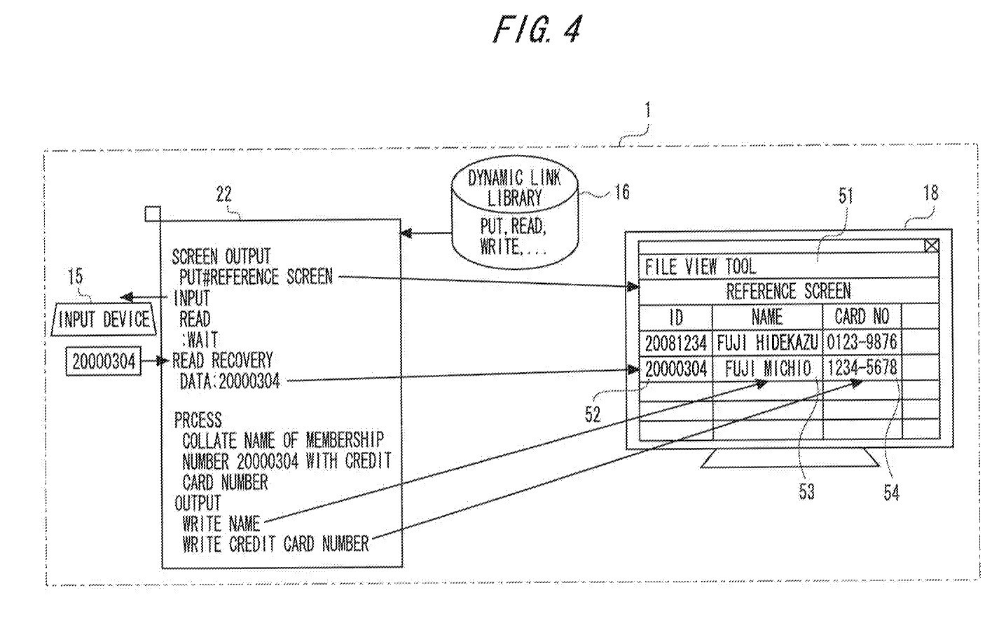

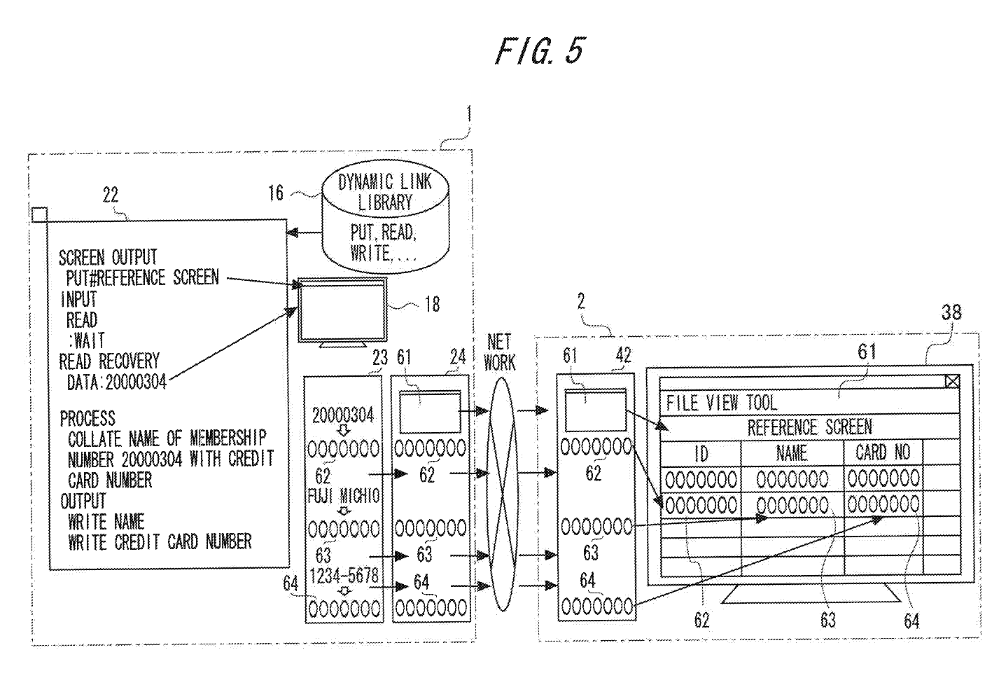

FIGS. 4 and 5 are explanatory diagrams each illustrating an operation related to the screen sharing in the case of utilizing reference software. FIG. 4 illustrates a state in which a reference screen is displayed on the display device 18 when using the reference software in the server-side device 1. FIG. 5 illustrates a state of the screen display shared system 10 where the reference screen in FIG. 4 that is shared with the server-side device 1 is displayed on the client-side device 2.

In the server-side device 1, the OS provides general-purpose functions required by many application software, such as reading the input data or outputting the data to the display device 18. Namely, the application software uses an application program interface (API) of the OS which is provided is a form of the dynamic link library (dll), when executing the general-purpose function.

The read or write operation involve reading and utilizing of modules such as READ, PUT, WRITE in the dynamic link library “dll”.

In the embodiment, in addition to the function modules READ, PUT or WRITE, a function for generating a copy image that the server-side device and the client-side device share with each other, is added to the “dll”.

For example, in the case of executing the PUT, the CPU 12 functions as the extraction discriminating unit 22, and executes a function of transferring the GUI screen to the linkup server unit 24, in addition to the function of extracting the designated GUI screen from the storage unit 16 and controlling the display control unit 21 to display the extracted GUI screen.

FIG. 4 illustrates an example in which the extraction discriminating unit 22 acquires the reference screen designated by an option of the PUT from the storage unit 16, and controls the display device 18 to display a reference screen 51.

Moreover, the extraction discriminating unit 22 copies the reference screen, and transfers the copied reference screen 61 to be shared with the client-side device 2 to the linkup server unit 24, as depicted in FIG. 5.

Further, the CPU 12 functions as the extraction discriminating unit 22 in the case of executing the READ operation. The CPU 12 non-displaying the inputted data and transfers the non-displaying data to the linkup server unit 24, in addition of the function of waiting for the input from the input unit 15 such as the keyboard or the mouse, transferring the inputted data to the application software and displaying the inputted data in a designated input box.

FIG. 4 illustrates an example in which the extraction discriminating unit 22 extracts “20000304” as the inputted data from the keyboard through the READ function, and gets the inputted data to be displayed in an ID input box 52 on the display device 18. The extraction discriminating unit 22 copies the inputted data and transfers the inputted data to the non-displaying unit 23 as illustrated in FIG. 5, while the non-displaying unit 23 non-displays the inputted data by converting the inputted data into predetermined codes. Then, the non-displaying unit 23 transfers non-displayed inputted data 62 to the linkup server unit 24. Note that function of the extraction discriminating unit 22, the non-displaying unit 23 and the linkup server unit 24 is realized by the program processed by the CPU 12 in the embodiment, and hence the CPU 12 processes the data of these units. In the embodiment, the data transfer among the extraction discriminating unit 22, the non-displaying unit 23 and the linkup server unit 24 may connote a handover of the data via the main memory 13 when the CPU 12 moves to the respective steps for actualizing the functions of the respective units 22, 23 and 24.

When an ID is inputted, the CPU 12 searches a database stored in the storage unit 16 for a name and a credit card number each associated with the inputted ID through the function of the reference software, and writes the name and the credit card number to the reference screen 51 by the API, e.g., the WRITE.

The CPU 12 functions as the extraction discriminating unit 22 in the case of executing the WRITE operation. The CPU 12 copies the output data and transfers the output data to the non-displaying unit 23 in addition to the function of extracting the designated output data and writing the output data in a designated field. The non-displaying unit 23 transfers non-displayed pieces of output data 63, 64 to the linkup server unit 24.

FIG. 4 illustrates an example in which the extraction discriminating unit 22 extracts a name [Fuji Michio] and a credit card number [1234-5678] of a member having a membership number [20000304] as the designated output data owing to the original function of the WRITE, and writes the extracted name and the credit card number to a name output box 53 and a card No. output box 54 on the display device 18, respectively. Moreover, the extraction discriminating unit 22, as depicted in FIG. 5, copies the inputted data and the output data, and transfers the inputted data and the output data to the non-displaying unit 23. The non-displaying unit 23 transfers the non-displayed pieces of data 62, 63, 64 to the linkup server unit 24. The extraction discriminating unit 22 may form the copied display information for the linkup. For example, an attribute representing the information for the linkup may be added to the copied display information in order to distinguish the copied display information from the original display information to be displayed on the display device 18. Namely, the display information in which the attribute for the linkup is added is not displayed on the display device 18 but is transferred to the non-displaying unit 23 or the linkup server unit 24.

The linkup server unit 24 transmits the display information such as the reference screen transferred from the extraction discriminating unit 22 and the I/O data transferred from the non-displaying unit 23 to the client-side device 2. When the linkup server unit 24 gives a transmitting instruction, the display information is packetized by a TCP/IP (Transmission control Protocol/Internet Protocol) layer of the OS, and the CCU 17 transmits the packets via the network.

The client-side device 2 received the display information from the server-side device 1 transfers the display information received by the linkup client unit 42, i.e., the reference screen and the I/O data to the display control unit 41. The display control unit 41, gets the display device 38 of the client-side device 2 to display the reference screen 61, inputs the input information 62 to the input box and writes the output information 63, 64 to the output box, based on the display information, as illustrated in FIG. 5 thereby reproducing the screen of the server-side device 1 on the display device 38 of the client-side device 2. Note that the input information 62 and the output information 63, 64 have been non-displayed (or made unrecognizable) by the server-side device 1 and are therefore displayed in the non-displaying mode, i.e., in the way of being replaced with predetermined codes in the client-side device 2.

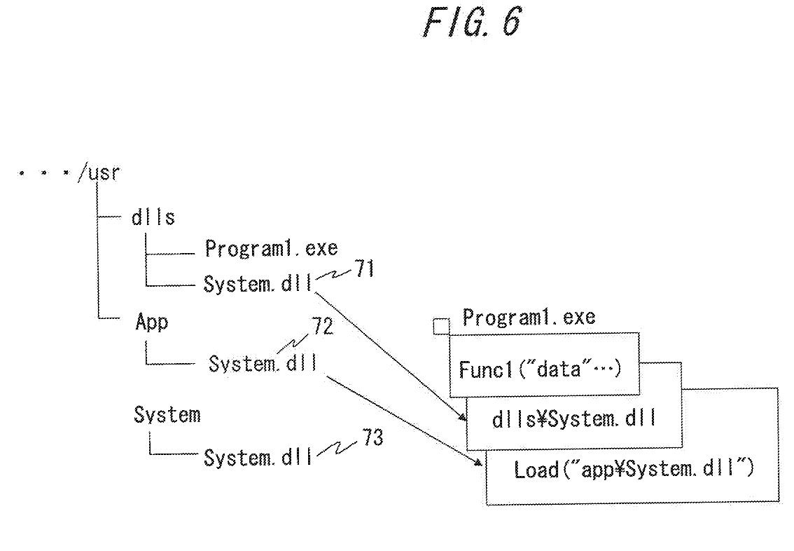

FIG. 6 is a diagram of a technique of implementing the “dll” in the case of starting up the extraction discriminating unit 22.

In FIG. 6, “dlls” becomes a current directory in the case of executing Program1.exe. Therefore, when executing Program1.exe, System.dll 71 stored in the current directory is read out. As indicated by an arrowhead, Program1.exe loads dlls¥System.dll ahead of others.

If “dll” is not stored in the current directory “dlls” and if “dlls¥System.dll” can not be loaded, “dll” in the directory designated by the user is read out. In the embodiment, the user designates a directory “App”, “dll” stored in this designated directory, i.e., System.dll 72 in the example of FIG. 6, is read out. Namely, as indicated by an arrowhead, Program1.exe performs loading such as Load(“app¥System.dll”).

Moreover, if “dll” is not stored in the current directory “dlls” and if the user does not designate the directory, “dll” stored in the system directory “System”, System.dll 73 in the example of FIG. 6, is read out.

The server-side device 1 stores System.dll 71 having the functions of the extraction discriminating unit 22 and the non-displaying unit 23 in the embodiment in the directory “dlls” serving as the current directory when starting up, e.g., a screen shared target program, and stores System.dll 73 having none of the functions in the embodiment in the system directory “System”. With this scheme, in the case of starting up the screen shared target program, System.dll 71 is read from the current directory “dlls”, and the functions of the extraction discriminating unit 22 and the non-displaying unit 23 are realized, thus sharing the screen. Then, in the case of starting up a screen shared non-target program, System.dll 73 is read from the system directory “System”, and the screen is not shared.

Further, System.dll 71 may not stored in the current directory “dlls” of each program, System.dll 72 having the functions of the extraction discriminating unit 22 and the non-displaying unit 23 in the embodiment is stored in the directory “App” designated by the user, and System.dll 73 having none of the function of any one of the elements in the embodiment is stored in the system directory “System”. With this scheme, when starting up the screen shared target program, the functions of the extraction discriminating unit 22 and the non-displaying unit 23 are actualized by reading System.dll 72 from the directory “App” designated by the user, thereby sharing the screen. Then, when starting up the screen shared non-target program, System.dll 73 is read from the system directory “System”, and the screen is not shared.

Moreover, System.dll 72 having the functions of the extraction discriminating unit 22 and the non-displaying unit 23 is stored in the system directory “System”, and System.dll 71 having none of the functions in the embodiment is stored in the current directory “dlls” of the screen shared non-target program. With this scheme, when starting up the screen shared non-target program, System.dll 71 is read from the current directory “dlls” with the result that the screen is not shared, and, when starting up the program other than the above, the functions of the extraction discriminating unit 22 and the non-displaying unit 23 are realized by reading System.dll 73 from the system directory with the result that the screen is shared.

An in-depth description of the screen shared operation will next be made.

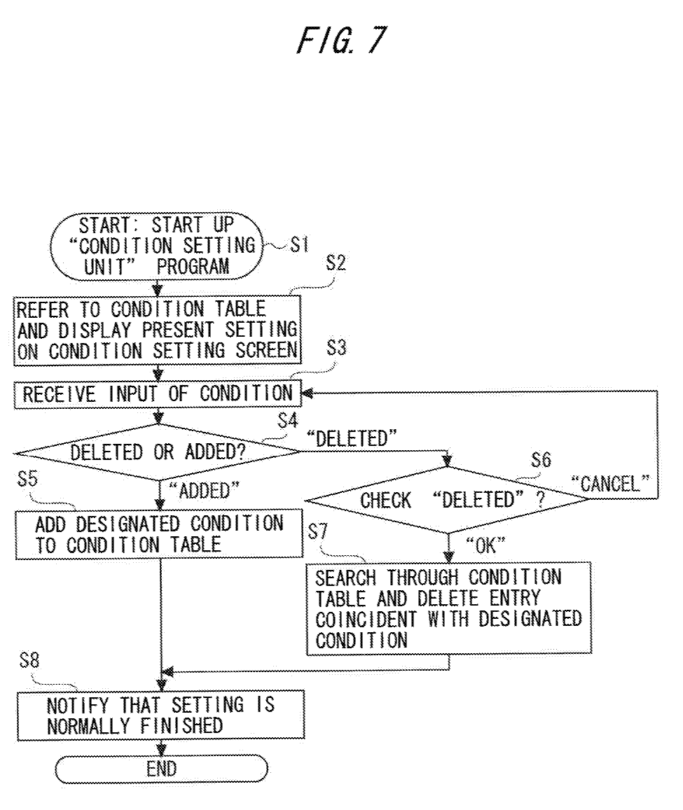

FIG. 7 is an explanatory diagram of a condition setting process operated by the condition setting unit 25.

When the user of the server-side device 1 selects a condition setting process, the CPU 12 reads a condition setting program from the storage unit 16 and executes this program, thereby functioning as the condition setting unit 25 (S1).

The condition setting unit 25 refers to the condition table, then displays the present setting on a condition setting screen (S2), and waits for the user to select the condition displayed on the condition setting screen (S3).

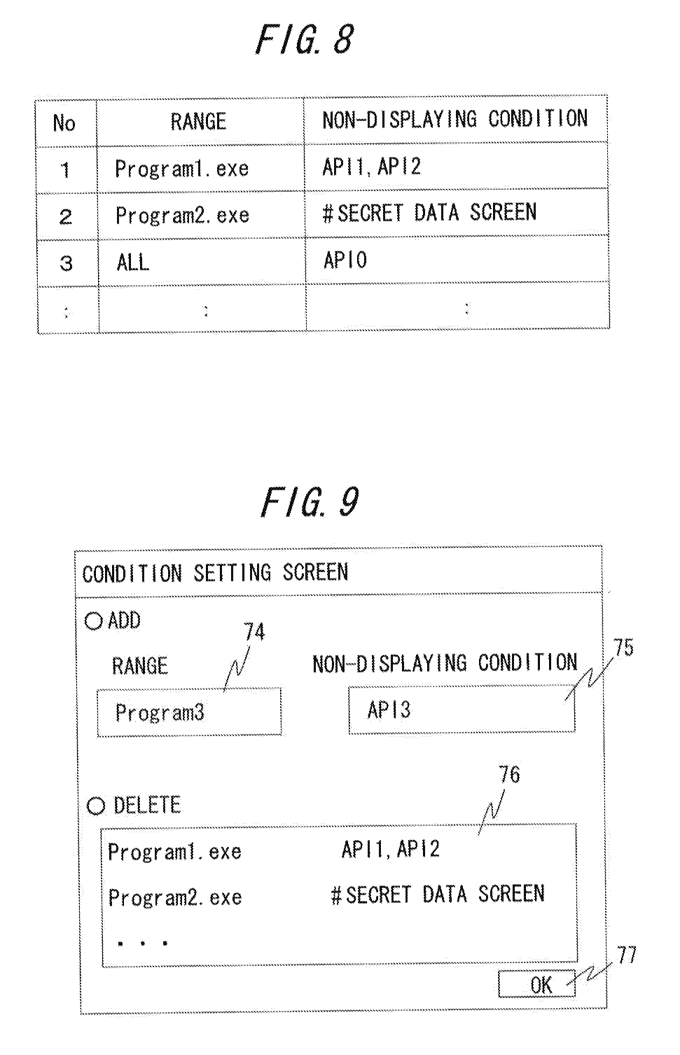

FIG. 8 is one example of the condition table, and FIG. 9 is an example of the condition setting screen. In the condition table of FIG. 8, the condition in No. 1 represents that the data processed by API1, API2 is non-displayed (made unrecognizable) in distinction from the secret data in a range of Program1.exe.

The condition in No. 2 connotes that a “# secret data screen” is non-displayed in the range of Program2.exe. The condition in No. 3 represents that the data processed by API0 is non-displayed in distinction from the secret data in a range of all the program.

The condition setting screen illustrated in FIG. 9 includes an input box 75 for inputting the non-displaying condition, an input box 74 for inputting a non-displaying condition applying range, and a selection box 76 for selecting the condition to be deleted. The present setting is displayed in the selection box 76, and the condition to be deleted can be selected.

When the user inputs the range and the non-displaying condition to the input boxes 74, 75 and selects an OK button 77, the condition setting unit 25 determines that the condition is added (S4, added), and adds the inputted non-displaying condition to the condition table (S5).

On the other hand, when the user selects the condition to be deleted on the condition setting screen and selects the OK button 77, the condition setting unit 25 determines that the condition is deleted (S4, deleted), and a dialog for checking “deleted” is displayed on the display device 18 (S6).

When the user selecting “OK” in the dialog displayed on the display device in the process in S6, the condition setting unit 25 searches through the condition table and thus deletes an entry coincident with the designated condition from the condition table (S7). Note that if the user selects “cancel” in the dialog in S6, the condition setting unit 25 loops back the process to S3 and prompts the user to input the condition.

Then, if the condition is added to the condition table in S5, or if the designated condition is deleted from the condition table in S7, a message for notifying that the setting is normally finished is displayed on the display device 18 (S8), and the condition setting process is terminated.

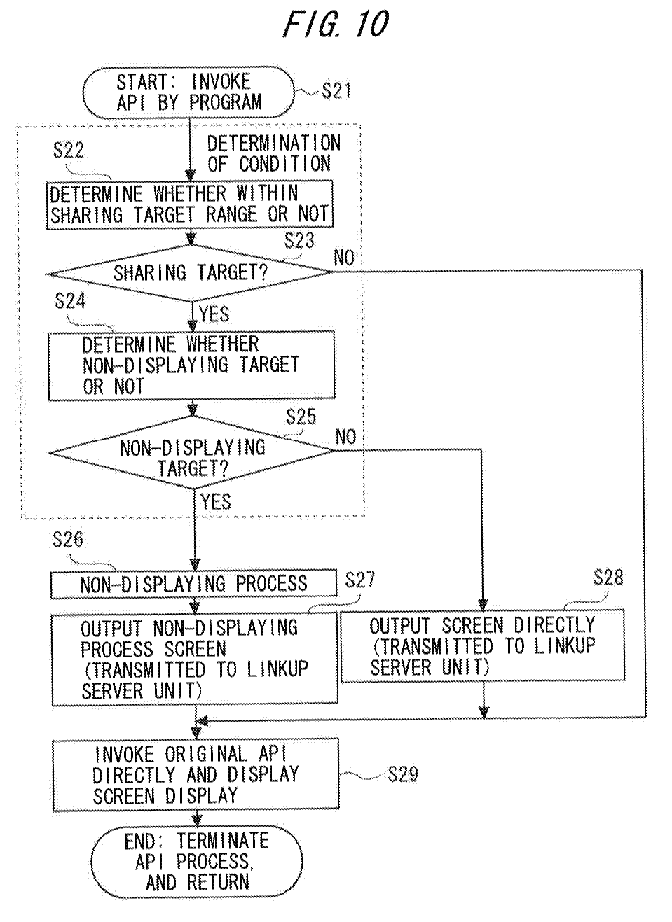

FIG. 10 is an explanatory diagram of a non-displaying process.

When the user starts up the program, the CPU 12 loads “dll” and starts up a monitoring target program. When the started program invokes the API related to the display such as “write” and “disp”, the CPU 12 operates as the extraction discriminating unit 22 (S21).

The extraction discriminating unit 22 refers to the condition table and determines whether or not the invoked API is within the sharing target range, i.e., within the non-displaying condition applying range. For example, if the non-displaying condition applying range is designated by a program name, the extraction discriminating unit 22 acquires the name of the program which invokes the API, and determines whether or not the condition table contains the entry coincident with the acquired program name (S22).

If the program is the sharing target (S23, Yes), the extraction discriminating unit 22 further determines whether or not the invoked API is the non-displaying target, i.e., whether or not the display information processed by the API s the secret data (S24).

If the display information is the non-displaying target information, i.e., the secret information (S25, Yes), the extraction discriminating unit 22 copies the display information designated as a parameter of the API and transfers the copied display information to the non-displaying unit 23. The non-displaying unit 23 non-displays the secret information transferred from the extraction discriminating unit 22 (S26). Then, the non-displaying unit 23 transfers the non-displayed secret information to the linkup server unit 24 (S27).

On the other hand, if the display information is the information other than the secret information in S25, in other words, if the display information is not the non-display target information (S25, No), the extraction discriminating unit 22 transfers the display information directly to the linkup server unit 24 without non-displaying the display information (S28).

Moreover, after S27 or S28, the extraction discriminating unit 22 transfers the display information to the display control unit 21, and the display information is displayed on the display device 18by the invoked API.

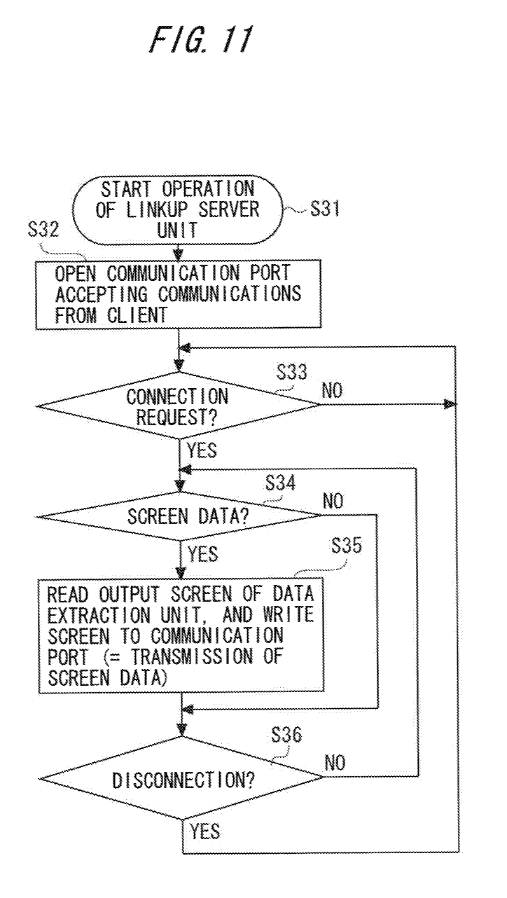

FIG. 11 depicts an operation of the linkup server unit 24.

In the embodiment, in advance of the connection with the client-side device 2, the linkup server unit 24 is started up beforehand and made to remain residing. For instance, the CPU 12, when starting up the server-side device 1, reads the program module for the data linkup and executes the program module, thereby starting the operation as the linkup server unit 24 (S31).

To begin with, the linkup server unit 24 opens a port for accepting the communications and waits for the connection to be given from the client-side device 2 (S32).

Upon receiving the connection request from the client-side device 2 (S33, Yes), the linkup server unit 24 establishes the connection with the client-side device 2, and determines whether or not the screen data is transferred from the extraction discriminating unit 22 (S34).

If no display information transferred from the extraction discriminating unit 22 (S34, No), the linkup server unit 24 checks whether the client-side device is disconnected or not. If the client-side device is not disconnected (S36, No), the link up server waits for the display information from the extraction discriminating unit 22. If the display information is transferred from the extraction discriminating unit 22 (S34, Yes), the linkup server unit 24 writes the display information outputted from the extraction discriminating unit 22 to the communication port, and transmits the display information to the client-side device 2 (S35).

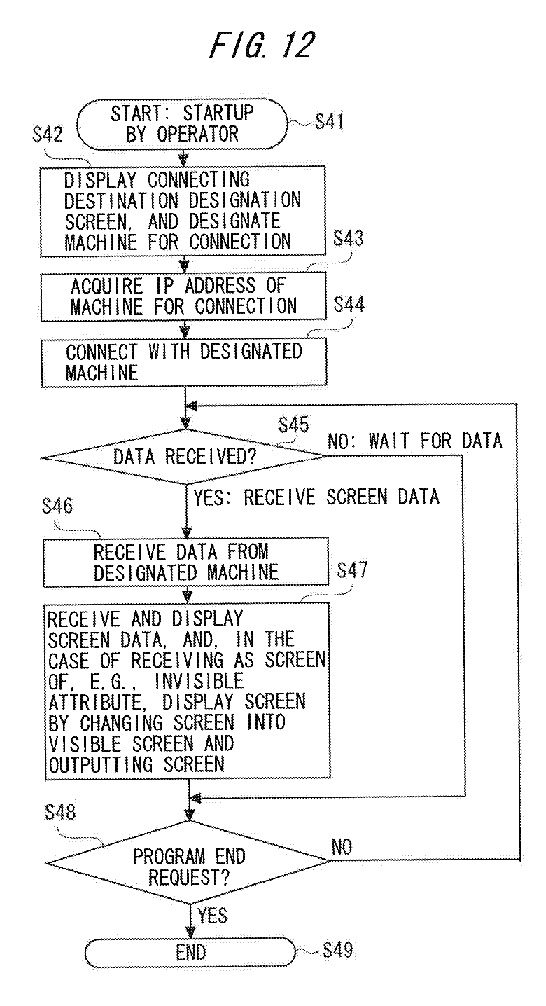

FIG. 12 is an explanatory diagram of an operation of the linkup client unit 42 in the client-side device 2.

When the operator gives an instruction of starting up the application software for the linkup, the CPU 32 of the client-side device 2 reads the application software for the linkup from the storage unit 36 and executes the application software, thereby operating as the linkup client unit 42 (S41).

The linkup client unit 42 promts the operator to designate a connecting destination by displaying a connecting destination designating screen on the display device 38 (S42).

In the case of receiving the designation of the connecting destination from on the connecting destination designating screen, the linkup client unit 42 acquires, from the storage unit 36, an IP address of the server-side device 1, which is associated with the designated connecting destination (S43).

Next, the linkup client unit 42 transmits the connection request addressed to the acquired IP address and thus connects with the server-side device 1 (S44).

Then, the linkup client unit 42 waits for receiving the screen data from the server-side device 1 (S45, No). If there is the display information from the server-side device 1 (S45, Yes), the display information is received from the designated machine (S46).

The linkup client unit 42 transfers the received display information to the display control unit 41 to display the received information to the display device 38 (S47). Note that if the attribute for the linkup is attached to the received display information, the linkup client unit 42 organizes the information into the normal display information by removing the attribute for the linkup and transfers the display information to the display control unit 41, in which the display information is displayed.

The linkup client unit 42 repeats the processes in S45-S47 till a program end request is given (S48, No) and, when receiving the program end request (S48, Yes), terminates the processing (S49).

As described above, the screen shared system, the information processing device, the non-displaying method, the non-displaying program or a recording medium of the present embodiment, it is feasible to provide a technology of realizing the non-display of the secret information in the case of sharing the display screen with other devices on a simple device configuration. Further, the server-side device 1 transmits the display information to the client-side device 2, and the display screen of the server-side device 1 is reproduced based on the display information received by the client-side device 2, whereby the screen on the server-side device 1 can be shared with the client-side device 2.

Especially, the server-side device 1 non-displays the secret information and transmits the secret information to the client-side device 2, and hence the secret information is not known by people other than the persons concerned. Therefore, a technical support and arrangements can be conducted in a way that shares the screen with the external client-side devices 2 such as outside the office and outside the home.

Moreover, the screen sharing and the non-displaying process are realized by “dll” that does not depend on the specific application software, and it is therefore feasible to arbitrarily designate the shared screen without being limited to the application software.

Further, the target application can be designated, and hence there is no necessity for transferring the unnecessary data, e.g., the screen background and the display results of other applications, resulting in a reduction in data size and a light transfer load.

Incidentally, an available scheme is that not only the screen is shared, but also the operator of the client-side device operates the shared screen, thus enabling the server-side device 1 to be operated. For example, the linkup operation unit 43 transmits, to the server-side device 1, a selected menu in the window displayed on the screen shared by the operator of the client-side device 2 and the information about the operation performed by the keyboard and the pointing device such as inputting the data. The operation linkup unit 26 of the server-side device 1 receiving this operating information transmits the received operating information to the CPU 12 as the input signals from the input device such as the keyboard and the pointing device of the self-device, thereby reproducing the operation executed by the operator of the client-side device 2. Without being limited to this technique, any types of known techniques are available as the operation linkup technique with respect to the shared screen.

<Others>

Herein, the recording medium readable by the computer connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc are given as those demountable from the computer.

Further, a hard disc, a ROM (Read-Only Memory), etc. are given as the recording mediums fixed within the computer.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is

1. A non-displaying method of secret information by which a computer executes:
generating display information;
displaying a screen on a display device based on the generated display information;
discriminating secret information in the display information based on a predetermined condition;
non-displaying the secret information by converting the secret information into information having a specific form; and
transmitting the display information other than the secret information, and the converted secret information to another device.

2. The non-displaying method of secret information according to claim 1, wherein the computer further executes a setting of the predetermined condition for discriminating the secret information in the display information.

3. The non-displaying method of secret information according to claim 1, wherein the secret information is non-displayed by replacing the secret information with specified characters or images.

4. The non-displaying method of secret information according to claim 1, wherein a type of a command of getting user data to be displayed as the display information is set as the predetermined condition, and the display information displayed according to this type of command is discriminated from the secret information.

5. An information processing device comprising:
a processing unit configured to generate display information;
a display control unit configured to making a display device to display a screen based on the generated display information;
a discriminating unit configured to discriminate secret information in the display information based on a predetermined condition;
a non-displaying unit configured to non-display the secret information by converting the secret information into a specific information; and
a transmitting unit configured to transmit the display information other than the secret information, and the converted secret information to another device.

6. The information processing device according to claim 5, further comprising a condition setting unit configured to set a condition for discriminating the secret information in the display information.

7. The information processing device according to claim 5, wherein the non-displaying unit non-displays the secret information by replacing the secret information with specified characters or images.

8. The information processing device according to claim 5, wherein a type of a command of getting user data to be displayed as the display information is set as a condition, and the discriminating unit discriminates the display information displayed according to this type of command from the secret information.

9. A storage medium readable computer, storing a non-displaying program of secret information, which makes the computer execute:
generating display information by an arithmetic process;
getting a display device to display a screen based on the display information;
discriminating secret information in the display information based on a predetermined condition;
non-displaying the secret information by converting the secret information; and
transmitting the display information other than the secret information and the post-converting secret information to another device.

10. The storage medium according to claim 9, further making the computer execute a setting of a predetermined condition for discriminating the secret information in the display information.

11. The storage medium according to claim 9, wherein the secret information is non-displayed by replacing the secret information with specified characters or images.

12. The storage medium according to claim 9, wherein a type of a command of getting user data to be displayed as the display information is set as a condition, and the display information displayed according to this type of command is discriminated from the secret information.

13. A screen shared system comprising a first information processing device and a second information processing device,
the first information processing device comprising:
a processing unit configured to generate display information;
a display control unit configured to get a display device to display a screen based on the display information;
a discriminating unit configured to discriminate secret information in the display information based on a predetermined condition;
a non-displaying unit configured to non-display the secret information by converting the secret information; and
a transmitting unit configured to transmit the display information other than the secret information, and the converted secret information to another device,
the second information processing device comprising:
a receiving unit configured to receive the display information other than the secret information, and the converted secret information from the first information processing device; and
a display control unit configured to get a display device to display a screen based on the display information other than the secret information, and the converted secret information received by the receiving unit.
